(19) United States
(12) Patent Application Publication
(10) Pub. No.: US 2008/0078844 A1
(43) Pub. Date: Apr. 3, 2008

(54) Rain roof

(76) Inventor: Chad E. Latunski, Cordova, TN (US)

Correspondence Address: CHARLES F. RYE;PATENT ATTORNEY, FIFTH FLOOR, 8 SOUTH THIRD STREET, MEMPHIS, TN, 38103, US

(21) Appl. No.: 11/485,115

(22) Filed: Jul. 12, 2006

(51) Int. Cl. B05B 3/00

(52) U.S. Cl. 239/208; 239/565

(57) ABSTRACT

A fluid delivery system adapted for use in association with a structure positioned upon an area which benefit from application of fluid. The system includes sources of forced flow fluids, a controller to regulate and/or mix fluid, lumens to deliver the fluid to regulatable fluid dispersers, a computer to receive data and issue instructions according to parameters, saturation detector to determine the ratio of fluid to area material and environmental detector to encode data based on environmental conditions. The system may also be in communication with an external communication system to allow remote control and automatic retrieval of environmental predictions that are utilized in calculation of anticipated saturation from all sources to predict fluid delivery needs. The system also includes quick disconnect features to allow rapid removal of the controller and convenient drainage of the system.

### BACKGROUND OF THE INVENTION

1. Introduction

The present invention relates to a fluid delivery system that is adaptive to irrigation of grounds around a building or any other situation in which the area around and a structure benefit from the application of fluid.

2. Prior Art

The use of an elevated portion of a structure to support irrigation sprinklers combined with remote sprinklers is known in the art.

By way of example, U.S. Pat. No. 4,428,434 to Gelaude discloses an automatic fire protection system.

U.S. Pat. No. 4,491,657 to LeLande, Jr. discloses a fire suppression system.

U.S. Pat. No. Des. 343,888 to Rupp discloses a fire fighter water manifold.

U.S. Pat. No. 5,165,482 to Smagac et al. discloses a fire deterrent system for structures in a wildfire hazard area.

U.S. Pat. No. 5,083,618 to Hayes discloses a bush fire protection of buildings.

U.S. Pat. No. 4,858,395 to McQuirk discloses fire protection for structures.

U.S. Pat. No. 5,366,021 to Coleman discloses fire fighting equipment for use in association with homes equipped with swimming pools.

These systems do not describe mixing of fluids from alternate sources, quick removal of a controller, establishing a drainage point, setting the distributors according to a best fit of the intended area, saturation detectors, environmental detectors, utilizing prediction data to program a controller or connection to a communication system. In these respects, the fluid delivery system according to the present invention substantially departs from the prior art providing a system which is far more flexible to meet the needs for fluid delivery to areas surrounding a structure.

### SUMMARY OF THE INVENTION

This invention's preferred embodiment is primarily an irrigation system generally for single family dwellings however, it can be adapted to larger structures and address other fluid applications such as fire suppression. Freezing damage to water control devices is addressed by positioning transfer lumens to drain to a common point and quick disconnect fittings to allow convenient removal of the fluid control unit. Modern adjustable sprinklers can be tailored to wetting the desired area. Locating the upper lumens in gutters and drain spouts elevate the system which increases the spray reach with minimum visual impact. Areas not reached by the elevated system are addressed by lower lumens and use of existing posts or trees to provide height were practicable. Relatively inexpensive commercially available water control units allow the user to set timing for watering and by alternating quick disconnects can be managed as separate zones.

In more sophisticated embodiments saturation detectors give data on ground moisture levels which can indicate actual water needs and trends to coordinate with natural moisture movement to assist in conservation. Environmental data as simple as rain detection to turn off irrigation improves the system and can include data analysis to predict ground moisture loss to evaporation and weather prediction to optimize water use and develop a reliability history. Although not readily commercially available the technology exists to produce sprinklers that can alter all of their output characteristics in response to digital commands to give even greater flexibility such as more exact volume to spray area control and wind drift adjustment. The water control unit can encode actual water volume transferred and communicate with a computer which would analyze data from all components and communicate over the internet to allow remote control and group control to further assist in water management for a community. The water controller would have the capacity to receive a second fluid source which can be concentrate or diluted chemicals that would mix with the primary water. The controller would also accommodate dividing the area into zones which allows variation of chemical/water application. The invention further accommodates use of water eluding and similar subterranean irrigation which has the greatest utilization/conservation actual and potential results:

### BRIEF DESCRIPTION OF THE DRAWINGS

FIG. 1. is a view of an area with a structure with an upper and lower lumen fluid dispersing unit.

FIG. 2. is a block drawing of the fluid and data systems.

### DETAILED DESCRIPTION OF THE DRAWINGS

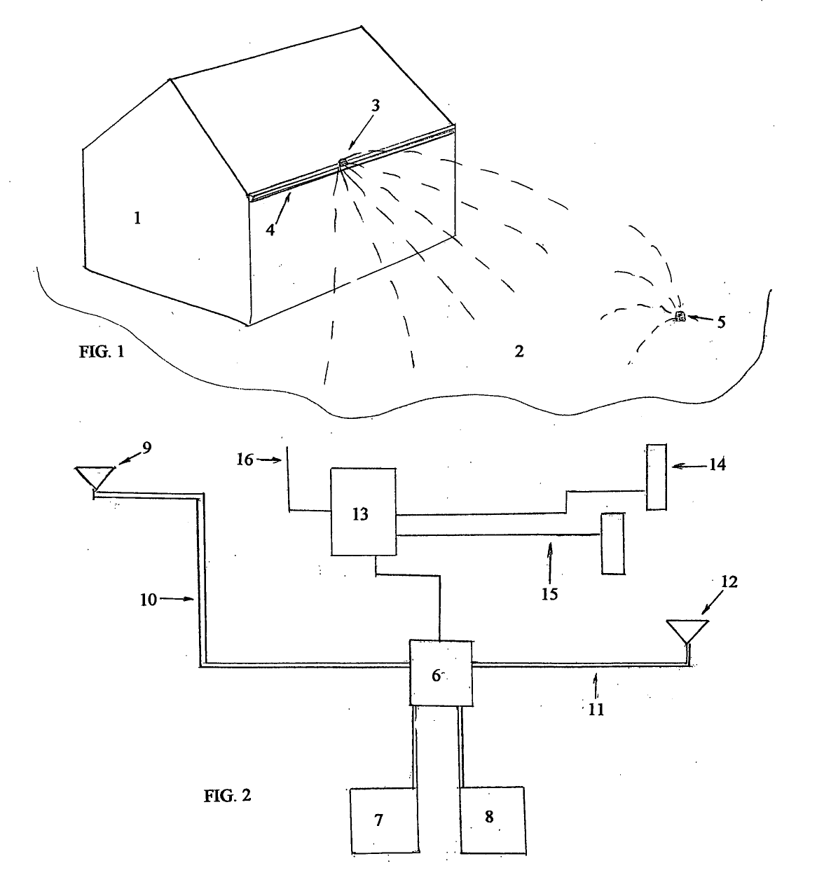

FIG. 1. shows structure 1 on area 2 with upper fluid dispenser 3 on gutter 4 and fluid dispenser 5 on area 2.

FIG. 2. shows fluid controller 6 in fluid communication with primary fluid source 7 and secondary fluid source 8. Fluid dispenser 9 is in communication with upper lumen 10 and controller 6 as is lower lumen 11 and fluid dispenser 12. Digital device 13 is shown in electrical communication with fluid controller 6 as are encoding environmental detector 14 and encoding saturation detector 13. External communication system connection line 16 is shown in electrical communication with fluid controller 6.

The preferred embodiment of this invention has been portrayed in the description and drawings and is not intended as a limitation on other adaptations of this invention. Those skilled in the art can envision various adaptations of this invention to accommodate general and specialized needs for fluid application on an area

I claim:

1. An improved fluid delivery system comprising, in combination:
a structure located on an area which benefit from application of fluid(s);
said structure having at lease one portion elevated above said area;
at least one elevated lumen;
at least one vertical lumen;
a forced flow primary fluid supply;
at lest one forced flow secondary fluid supply;
at least one fluid controller with each inlet and outlet having quick disconnect fittings in fluid communication with said primary and secondary fluid supply;
at least one regulatable fluid disperser;
said elevated lumen mounted to said structure in fluid communication with said vertical lumen and said regulatable fluid disperser and positioned to drain any internal free flowing fluid toward said vertical lumen;
said vertical lumen in fluid communication with said fluid controller;
a digital device and instruction set which receives parameters and outputs data describing settings for adjustments of said fluid controller and regulatable fluid disperser(s) for optimum application pattern of fluid to said area; and
at least one of the elements of this invention hidden within features of said structure.

2. The invention of claim 1 further comprising:
said fluid controller being automated and programmable for at least fluid ratio, volume/pressure and timing.

3. The invention of claim 1 further comprising;
at least one lower lumen;
at least one regulatable fluid dispenser;
said lower lumen generally below the surface of said area and each positioned to drain any internal free flowing fluid to a sump in fluid communication with at least one said regulatable fluid dispenser and said fluid controller.

4. The invention of claim 1 further comprising;
at least one deflection guard which shields an area from fluid spray.

5. The invention of claim 1 further comprising;
at lease one electronic device generally video/audio and/or antenna disguised as said regulatable fluid dispenser;
said electronic device mounted to said structure to appear in unison with said elevated regulatable fluid dispenser(s) and/or mounted upon said regulatable fluid dispenser;
a communication system associated with said electronic device.

6. An improved fluid delivery system comprising, in combination:
a structure located on an area which benefit from application of fluid;
said structure having at lease one portion elevated above said area;
at least one elevated lumen;
at least one vertical lumen;
at least one lower lumen;
a forced flow primary fluid supply;
at lest one forced flow secondary fluid supply;
at least one automated programmable fluid controller with each inlet and outlet having quick disconnect fittings in fluid communication with said primary and secondary fluid supply;
at least two regulatable fluid disperser;
said elevated lumen attached to said structure in fluid communication with said vertical lumen and said regulatable fluid disperser and positioned to drain any internal free flowing fluid toward said vertical lumen;
said vertical lumen in fluid communication with said fluid controller;
said lower lumen in fluid communication with said regulatable fluid dispenser and said fluid controller and generally below the surface of said area and positioned to drain any free flowing fluid to a sump(s);
a digital device and instruction set which receives data and outputs instructions for said fluid controller and describing settings for adjustments of said regulatable fluid disperser for optimum application pattern of fluid delivery to said area; and
at least one of the elements of this invention hidden within features of said structure.

7. The invention of claim 6 further comprising:
said fluid controller having at least one data port and adaptive to sending and receiving data;
a digital device in communication with said controller; and
a digital instruction set which enables said digital device to receive and analyze data and send operation instructions to said fluid controller.

8. The invention of claim 6 further comprising:
said controller encoding volume transfer and having at least one data port;
a digital device in communication with said controller;
a digital instruction set enabling said digital device to receive and analyze data and send operation instructions to said fluid controller.

9. The invention of claim 6 further comprising;
at least one data encoding saturation detector in communication with said digital device which detects the ratio of said primary and/or secondary fluid compared to the material of said area located at predetermined site generally below the surface of said area; and
a digital instruction set which allows said digital device to receive data from said saturation detector and send operation instructions to said fluid controller.

10. The invention of claim 6 further comprising;
at least one data encoding environment detector in communication with said digital device sensitive to at least one environmental condition ambient to said area positioned at predetermined site generally above the surface of said area; and
a digital instruction set which enables said digital device to receive data from said environmental detector, and environmental predictions and send instructions to said fluid controller based on real time data and predicted data.

11. The invention of claim 6 further comprising:
at least one external communication system;
said digital device in communication with said external communication system; and
a digital instruction set which allows said digital device to receive and transmit data on said external communication system.

12. The invention of claim 6 further comprising;
at least one deflection guard which shields an area from fluid spray associated with said regulatable fluid dispenser(s).

13. An improved fluid delivery system comprising, in combination:
a structure located on an area that benefit from application of fluid;
said structure having at lease one portion elevated above said area;
at least one elevated lumen;
at least one vertical lumen;
at least one lower lumen;
a forced flow primary fluid supply;
at lest one forced flow secondary fluid supply;
at least one programmable data encoding fluid controller, having at least one data port, in fluid communication with said primary and secondary fluid supply having quick disconnect connections for all inlet and outlets;
at least one external communication system;
a digital device in communication with said fluid controller and said external communication system;
at least one data encoding saturation detector which detects the ratio of said primary and/or secondary fluid compared to the material of said area in communication with said digital device positioned at a predetermined location generally below the surface of said area;
at least one data encoding environment detector sensitive to at least one environmental condition ambient to said area in communication with said digital device positioned at a predetermined location generally above the surface of said area;
at least two regulatable fluid disperser;
said elevated lumen attached to said structure in fluid communication with said vertical lumen and at least one said regulatable fluid disperser and positioned to drain any internal free flowing fluid toward said vertical lumen;
said vertical lumen in fluid communication with said fluid controller;
said lower lumen in fluid communication with at least one said regulatable fluid dispenser and said fluid controller and generally below the surface of said area and positioned to drain any free flowing fluid to a sump;
a digital device and instruction set which receives data and outputs data describing settings for adjustments of said fluid controller and said regulatable fluid disperser for optimum application pattern of primary and secondary fluid delivery to said area;
said fluid controller programmable to mix said primary and secondary fluid to a predetermined ratio, regulate total volumes dispensed and timing;
said digital device receives and analyzes data from said saturation and environmental detectors and sends instructions to said programmable fluid controller and may further receive and send data through said external communication system;
said digital device adaptive to receive and analyze environmental predictions and resets predetermined parameters in accordance with secondary parameters including economic data to optimize application of fluids;
at least one of the elements of this invention hidden within features of said structure.

14. the invention of claim 13 further comprising;
at least one deflection guard which shields an area from fluid spray associated with said regulatable fluid dispenser(s).

15. the invention of claim 13 further comprising;
at least one lower lumen secreting fluid at a predictable rate.

16. the invention of claim 13 further comprising;
said regulatable fluid dispenser comprising an electrically controllable fluid dispenser in communication with said digital device being automated to alter output and swept area

17. the invention of claim 13 further comprising;
at lease one electronic device generally video/audio and/or antenna disguised as said regulatable fluid dispenser;
said electronic device mounted to said structure to appear in unison with said elevated regulatable fluid dispenser(s) and/or mounted upon said regulatable fluid dispenser;
a communication system associated with said electronic device.

18. The invention of claim 13 further comprising:
two or more said programmable fluid controllers with associated elements defining zones on said structure and area.

19. The method of managing fluid application on an area comprising:
establishing optimum fluid presence/content data;
receiving site data comprising; environmental prediction data, saturation data and environmental data for an area;
establishing trend data based on site data over time;
receiving economic data for fluid use based on volume consumed and time of consumption;
comparing environmental prediction data over time to actual data for predicted time;
assigning reliability values to prediction data based on history;
generating instructions to fluid controller based on analysis of optimum fluid data, site data, trend data, and reliability values; and
transmitting fluid controller instructions over an intra communication system.

20. The method of claim 19 further comprising;
receiving data from multiple areas and developing region data; and
transmitting fluid controller instructions to each area.
